(19) United States
(12) Patent Application Publication
(10) Pub. No.: US 2005/0152774 A1
(43) Pub. Date: Jul. 14, 2005

(54) Modular support surface used in the transport of a group of containers

(76) Inventors: Frank D. Pierce, Pacific Grove, CA (US); Lee R. Marcum, Salinas, CA (US); Frank R. Nunes JR., Carmel Highlands, CA (US); Lynn E. Thompson, Yuma, AZ (US)

Correspondence Address: Garrettson Ellis;Seyfarth Shaw LLP, Suite 4200, 55 East Monroe Street, Chicago, IL, 60603, US

(21) Appl. No.: 10/755,108

(22) Filed: Jan. 9, 2004

(51) Int. Cl. B65F 9/00; E04D 1/00; E04B 2/00

(52) U.S. Cl. 414/809; 52/536; 52/588.1

(57) ABSTRACT

A grooved support surface, the support surface being defined by a first plurality of support modules which are held in side-by-side relation together. Individual support modules typically comprise an elongated body having at least a pair of flat segments, joined at a common side edge, and extending transversely to each other. The support modules together define a plurality of spaced, longitudinally extending grooves in the support surface.

### BACKGROUND OF THE INVENTION

As described in Nunes U.S. patent application Ser. Nos. 10/210,462 and 10/345,575, a method and apparatus is disclosed for transporting a group of containers without the need for a conventional pallet.

Containers of merchandise such as produce containers are typically transported in a group, strapped or otherwise secured to a pallet, which is typically made of wood.

As one cost and disadvantage of the shipment of products such as produce or manufactured items from a source of supply to the consumer, the respective pallets tend to make a one-way trip, where they accumulate at receiving sites, often forming a small mountain of pallets. This of course is obviously wasteful and costly.

By the inventions of Mr. Nunes, cited above, a system has been developed in which groups of containers may be handled in a conventional manner of pallet transportation, but the pallets, if present at all, are not transported for the entire journey along with the containers. This reduces the number of pallets required, and the one way flow of pallets from a production area to the customer, so that the customer is not burdened with great quantities of surplus pallets. Thus, a method is provided of transporting a group of containers without transporting the pallet, although the containers may initially rest on a pallet, if desired.

By this method, the prongs of a lifting device may be inserted into first, open grooves defined in a first support surface underneath the group of containers. The prongs are positioned to support all of the containers in the group. The containers are then lifted from the pallets, with the group of containers being transported by means of the lifting device to a transport vehicle.

The prongs of the lifting device then may be inserted into second, open grooves defined typically on the floor of a transport vehicle or other second support surface, to permit the group of containers to rest on the surface. One then withdraws the prongs from the second, open grooves. The containers may then be transported to the new destination.

Following this, the group of containers may be unloaded from the transport vehicle by inserting prongs of a second lifting device into the second, open grooves, and lifting and removing the group of containers from the transport vehicle. Then, optionally, the prongs of the second lifting device, carrying the group of containers, may be inserted into third, open grooves of another pallet, or a shelf, a floor, or other third support surface, to permit the group of containers to rest on the third support surface, followed by withdrawing the prongs of the second lifting device.

Thus, by this technique, efficient transportation of the group of containers from one location to another is provided without also transporting the pallets. A surplus of pallets does not have to accumulate at the new designation. This avoids the need of purchasing or manufacturing a constant supply of pallets at the original location where the containers are assembled into their groups.

The term “lifting device” may comprise any device that carries prongs and is capable of lifting a group of containers by those prongs, such as forklift vehicles, pallet jacks (hand operated and otherwise), overhead lifts, load transfer stations, and other kinds of lift trucks. These devices are modified in accordance with this invention to carry a container lifting member comprising prongs, which prongs are capable of lifting the containers and are capable of fitting into the various open grooves described above.

### DESCRIPTION OF THE INVENTION

In accordance with this invention, improvements are provided to the previously described invention of Mr. Nunes. Particularly, improved, grooved surfaces are provided for the use in storing and transporting of groups of containers, while wholly or partially eliminating pallets.

In accordance with this invention, a grooved support surface (such as a floor or shelf surface) is provided. While support surfaces resting on a subfloor will be specifically described, shelf or rack surfaces, pallet surfaces, and the like may be similarly used, as another kind of “subfloor”. A grooved support surface may be defined by a first plurality of support modules held in side-by-side relation together on a subfloor, or elevated on a rack, for example, carried on a shelf or only at their ends by the rack frame. Individual floor modules each comprise an elongated body having at least a pair of flat segments joined at a common side edge and extending transversely to each other. The floor modules together define a plurality of spaced, longitudinally extending grooves.

These grooves are proportioned so that they may be entered by a fork of a lifting device, which typically is a fork on a forklift having four or more prongs, so that the various prongs of the fork are relatively close together, to facilitate the lifting of a stack of boxes having multiple boxes in each layer of the stack, and frequently several layers of boxes in the stack, such as from one layer to six or eight layers of boxes. Thus, closely spaced prongs will tend to have more support and lifting capability for the individual boxes in the stack, without shifting and collapsing of the boxes through spaces between the prongs. For example, as described in the previously cited Nunes patent applications, the boxes may be of a conventional, rectangular shape, and may be positioned in the well-known five-down stack pattern, although other patterns may be used.

Optionally, at least some of the support modules present may have a cross section which is shaped essentially like three sides of a rectangle, i.e., a square U-shape. Optionally, at least some of the modules present may have a cross section shaped essentially like a rectangular S. These support modules may typically be made from extruded aluminum or another metal. They may be held in the desired side-by-side relation by tack welding, adhesives, bolts, or screws such as flathead screws, integrated locking devices, or any other desired and conventional technique.

In some embodiments, at least some of the support modules have ends that are joined to a ramp to facilitate the use of a known dock leveler while allowing the complete filling of a transport vehicle having a grooved floor in accordance with this invention. The ramp allows the withdrawal of the lifting device prongs after loading of the final stack of containers into the vehicle, providing smooth transition for the lifting device (forklift) wheels onto and off of the support modules. Also, the ramp permits advancing of forks carrying container stacks while the forks enter the grooves, without the forklift impacting the ends of the support modules. Such impact could cause bending and distortation of the modules, with sharp, upturned edges that could do damage to containers, and create unsafe, sharp edges for people working in the area. Typically, the ramp comprises a plurality of ramp modules which are held in side-by-side relation on the subfloor in their position abutting against the support modules.

For longer, grooved floors, a second plurality of support modules, held in side-by-side relation, may substantially abut the first plurality of support modules, with the second plurality of support modules being in end-to-end relation with the first plurality of support modules, and with the grooves aligned with each other so that the structure defines a single, integral, grooved floor or other support surface. Additionally, a third plurality of such support modules (and more) may also be added in similar manner, to achieve any desired length, without the individual support modules being inconveniently long for handling. Typically, such support modules may be order of 6 to 10 feet long, although they may be of any length that is convenient and appropriate. For example, their length can range from the length of a pallet to the length of a truck bed or a room.

The grooved support surface of this invention, comprising one or more pluralities of support modules and optionally the ramp described above, may rest on a subfloor which may particularly comprise the floor of a trailer, a large transport container, a railroad car, aircraft, or a boat, the floor of a storage room such as a cold room, a storage rack, or any other desired support surface, such as a shelf, on which containers are to be stored. The support surface provided by the floor modules of this invention may comprise a semi-permanent flooring which may be used to conveniently store stacks of containers and/or transport them, without the need for the owner to have to commit to a permanent modification. The grooved support surface of this invention may be laid down in the trailer of a semi-trailer truck, for example, or any other subfloor, without the owner of the trailer having to consider this a permanent modification. The grooved support surface of this invention can be used for a lengthy period of time, and then it may be removed without great difficulty, if that is desired, to restore the trailer or other enclosure to substantially its original condition.

Preferably, at least most of the support modules present comprise at least one horizontal, flat segment connected at opposite side edges to a pair of vertical, flat segments. The overall cross section of such a structure may be U-shaped, S-shaped, or another shape as desired. In some embodiments, at least some of the vertical segments of different floor modules which are next to each other are spaced from each other, in a manner disclosed below, for better weight support. Also, in some embodiments, at least some of the vertical segments have edges that enter into a groove defined at a horizontal segment of an adjacent support module, examples of which are shown below.

Further in accordance with this invention, improved retention of arrays of elongated modules may be provided by the use of a particular elongated module for placement on a subfloor surface, which comprises an elongated body having a cross-section generally like a squared-S. The body defines a pair of elongated channels having oppositely facing, open mouths. A first interlocking member is connected to the body and projects into one of the elongated channels. A second interlocking member is connected to the body and projects into the other of the elongated channels.

The elongated modules may be locked together in laterally abutting relation, with each of the interlocking members being in connection with an interlocking member of another of the modules, which are in laterally abutting relation therewith. In other words, the module of this invention may be part of an array of laterally abutting modules in which the first interlocking member of a particular module is connected to a second interlocking member of an adjacent module, and the second interlocking member of the particular module is connected to a first interlocking member of another of the modules on another side.

Typically, each of the elongated, open mouthed channels is defined by a bottom wall and a pair of sidewalls of the module. In one embodiment, the first interlocking member may comprise a longitudinally extending bar, connected to the bottom wall of one of the channels at a location spaced from the sidewalls. In the same embodiment, the second interlocking member may be connected to that sidewall which partially defines the elongated channel that is spaced from the first interlocking member, and which defines an outer side of the elongated body.

In some embodiments, the bottom wall of one of the elongated channels defines a hole for a retaining screw, to hold the module onto a subfloor.

In some embodiments, the laterally abutting modules may be longitudinally offset (staggered) from each other, particularly when arrays of modules are placed in end-to-end relation to cover a larger subfloor, and to avoid a linear seam between the end-abutting arrays of laterally abutting modules, and to create interlocking support modules.

In another aspect of this invention, a stack of containers may be placed onto a lifting device such as a forklift, typically having at least four lifting prongs, which are each preferably spaced apart by no more than about 10 inches. This method comprises: placing the stack of containers on a sheet support material which rests on a first support surface. One then advances the lifting device into grooves defined in the first support surface, to place the sheet and the stack of containers onto the prongs of the forklift. The sheets may be made of plywood, corrugated cardboard, plastic, or the like, and may desirably be a low friction material.

The containers may be lifted and transported to a new destination, as desired. Then, the lifting device prongs may be placed into grooves in a second support surface. The lifting device is then retracted, to place the sheet and stack of containers off of the forklift prongs and onto the second support surface.

The support surfaces used herein may be similar in nature to the types of “subfloor” as described above or they may comprise other support surfaces, but with the grooves formed therein.

It should be noted that attempts were previously made to use a sheet of low friction material in this manner, to place stacks of containers on conventional forklifts which have only two prongs. This work proved to be commercially unsuccessful. However, we have found that with the increase in number of lifting prongs, which are preferably spaced apart by no more than about 10 inches, and typically from about 4 to 7 inches, this system works well on grooved floors, without the need for pallets, in handling particularly less stable stacks of smaller containers.

### DESCRIPTION OF THE DRAWINGS

Referring to the drawings:

FIG. 1 is a fragmentary, perspective view of a truck trailer bed which carries one embodiment of the grooved floor of this invention.

FIG. 1A is a more complete, perspective view of a truck trailer carrying an embodiment of the grooved floor of this invention, in which a second plurality of floor modules and ramp modules is also present.

FIG. 2 is a perspective, exploded view of the modules of the grooved support surface of FIG. 1.

FIG. 3 is a transverse sectional view, partly exploded, of the grooved support surface of FIG. 1.

FIG. 4 is a transverse sectional view of the completely assembled support surface of FIG. 1.

FIG. 5 is an exploded, transverse sectional view of a portion of the grooved support surface of FIG. 4, to further show its construction.

FIGS. 6-9 are transverse sectional views of individual floor modules used in the construction of the support surface of FIG. 4.

FIGS. 10 and 11 are transverse sectional views, similar to FIGS. 3 and 4, of a modified embodiment of the grooved support surface, using a different arrangement of types of floor modules.

FIG. 12 is an exploded, transverse sectional view of a portion of the support surface of FIG. 11.

FIGS. 13-16 show transverse sectional views of various floor modules used in the embodiment of FIGS. 10-12.

FIG. 17 is a fragmentary, perspective view of an embodiment of the grooved floor of this invention, with a ramp.

FIG. 18 is a fragmentary, exploded perspective view of FIG. 17.

FIG. 19 is a sectional view taken along line 19-19 of FIG. 17.

FIG. 20 is a perspective view of another embodiment of this invention.

FIG. 21 illustrates the attachment of one embodiment of the laterally connected modules of this invention, which connect in overlapping relation, through respective first and second latch members.

FIG. 22 shows the two elongated modules illustrated in FIG. 21 connected together, and attached to a subfloor, with a third module in the process of being laterally connected to the other two.

FIG. 23 illustrates another embodiment of a laterally connected array of modules for placement on a subfloor surface, in which the laterally adjacent modules are longitudinally offset from each other.

FIG. 24 is a plan view of one end portion of an array of laterally connected modules similar to those of FIG. 23 in their laterally offsetting relationship.

FIG. 25 is a perspective view of a module for placement on a subfloor surface, in longitudinal connection with a slotted ramp of different embodiment from that shown in FIGS. 17 and 18, and having an air circulation opening.

FIG. 26 is a schematic view showing how an array of laterally connected modules, forming a grooved floor in accordance with this invention, can define an air circulation duct as part of the grooved floor provided by this invention to facilitate the maintenance of cooling of product resting on such a floor.

FIG. 27 illustrates how a grooved support surface defined by laterally connected modules of this invention, and a ramp in accordance with this invention, can accommodate a conventional dock leveler apparatus to permit the palletless stacking of product boxes into a trailer or the like while using such a dock leveler.

### DESCRIPTION OF SPECIFIC EMBODIMENTS

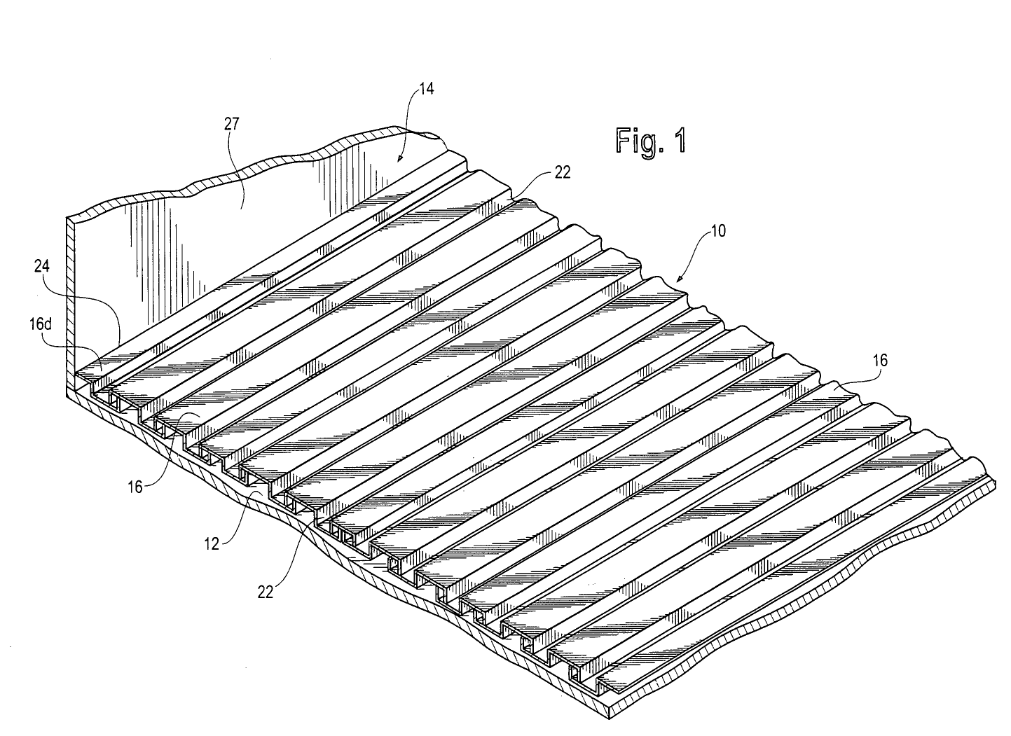

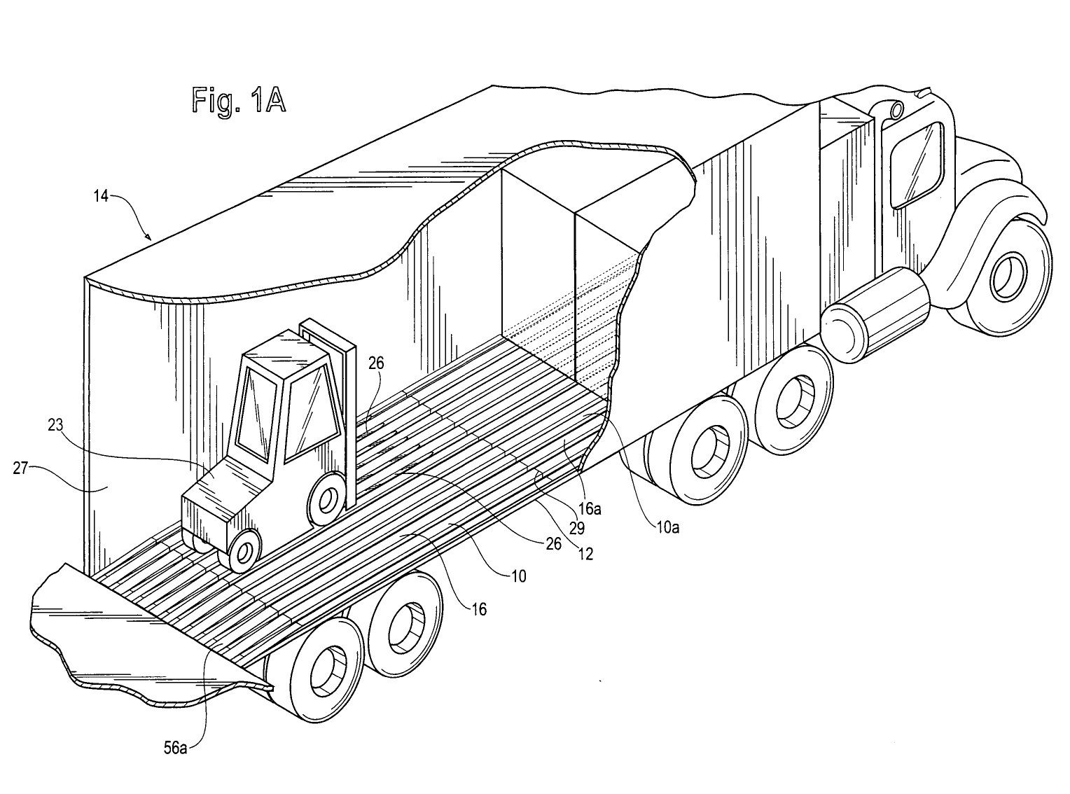

Referring to FIGS. 1-9, a grooved support surface 10 is shown, resting on a subfloor 12 of a truck trailer 14. Subfloor 12 may be substituted for by any other desired horizontal surface upon which stacks of packages or the like may be placed.

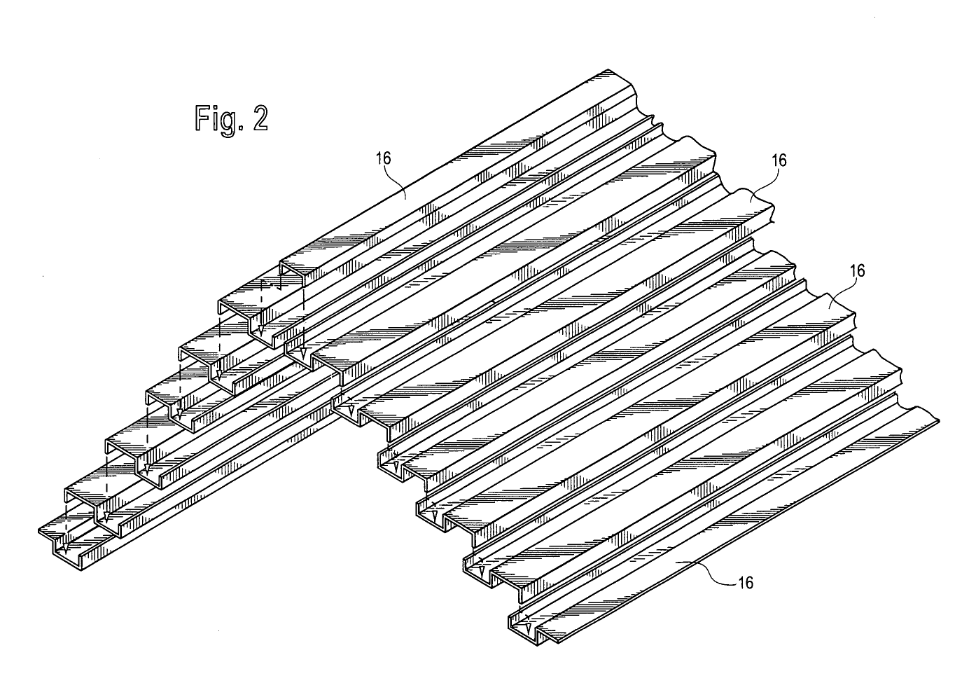

Grooved support surface 10 is defined by a first plurality of support modules 16, as particularly indicated by FIG. 2, which shows the respective support modules 16 in exploded configuration. Support modules 16 may come in a variety of different designs, as is necessary or desired to provide the desired grooved support surface. For example, as shown in FIGS. 6-9, four different designs of support modules 16a, 16b, 16c, 16d may be used.

The respective support modules 16 are held in side-by-side relation on subfloor 12 (or alternatively carried at their ends by the frame of a rack, or the like). The individual support modules 16 comprise an elongated body as shown and may be made, for example, out of extruded aluminum, or strong plastic, or another material. As shown, each of support modules 16a-16d has at least a pair of flat segments 18, 20 joined at a common side edge 19, and angled to be extending in one dimension transversely to each other, as shown in FIG. 8, The other designs of support modules of FIGS. 6, 7, and 9 may be similarly described. The support modules together define a plurality of spaced, longitudinally extending, upwardly open grooves 22, as particularly shown in FIG. 1.

The structure as illustrated in FIG. 1 may be used in conjunction with a forklift 23, (FIG. 1A) with individual lifting prongs 26 that are capable of fitting into grooves 22 to deposit, withdraw, and generally move stacks of containers to and from grooved surface 10 without the need of pallets. Grooved floor 10 may be resting on a truck trailer or railcar floor 12 as shown, or grooved floor 10 may rest on the surface of a shelf, or the floor of a room such as a cold room, or any other desired, horizontal surface where storage of stacks of containers is desired.

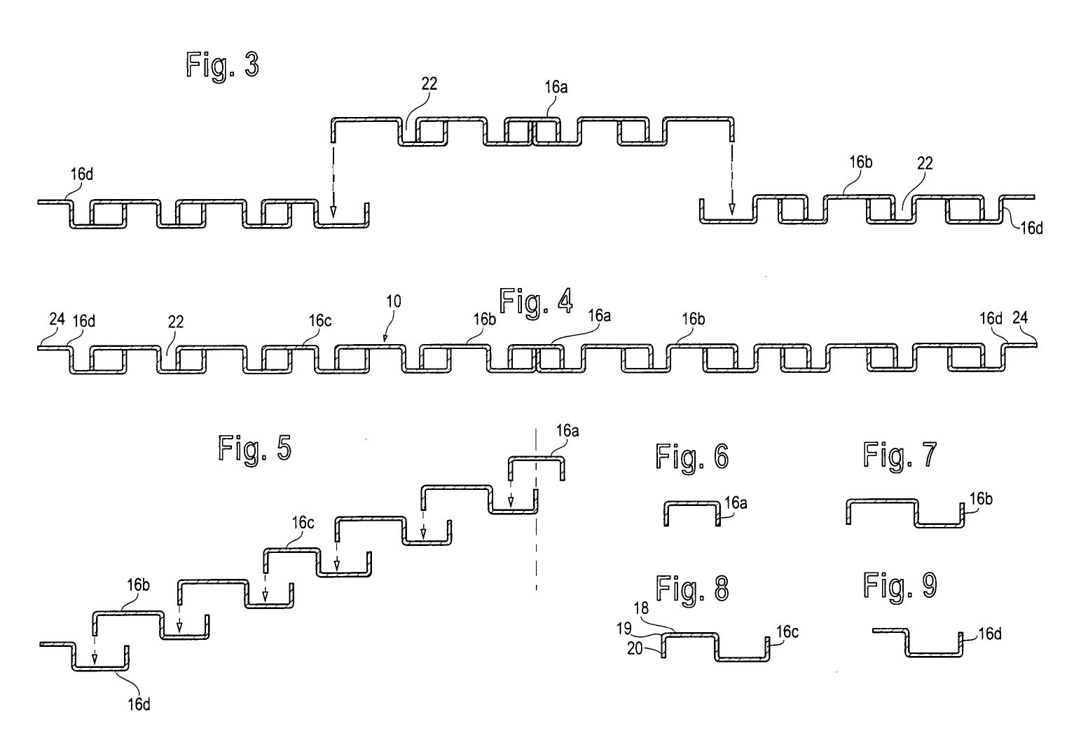

FIGS. 3 and 4 are cross sectional views showing how grooved floor 10 can be assembled from the individual support modules 16a-d, in a particular desired pattern. They may be easily and manually assembled in the desired pattern to provide a grooved floor of the desired spacing for grooves 22 and a desired overall width. Specifically, in this embodiment, some of the support modules 16 are labeled in FIGS. 3 and 4 according to their types, as illustrated in FIGS. 6-9. The side edges of grooved support surface 10, in this embodiment, is shown to be terminated with a support module 16d, so that a side edge 24 can be presented to wall 27 of the truck trailer (FIG. 1), a room, or a rack system support, to facilitate stability. If desired, a groove may be cut in the side 27 of the truck trailer with side edge 24 projecting into such a groove.

Accordingly, a grooved floor or other support surface 10 of many desired widths may be provided to fit the space allocated to it.

The respective support modules 16 may be secured in their desired, side-by-side relation by tack welding, or any other desired technique. Thus, a grooved floor or other surface may be provided upon which stacks of containers, without a pallet, may be placed and also retrieved.

As shown in FIG. 1A, a second plurality of support modules 16a may be added to the first grooved support surface 10, comprising a first plurality of support modules 16 as described above. The second support surface 10a also comprises such a plurality of support modules 16a, of similar design to modules 16, and may abut support surface 10 at end 29 of modules 10, in end-to-end relation, to lengthen the overall, grooved support surface. More than one of such sets of support modules 10 may be so applied, either at the sides or at the ends of other groups of support modules 10 or 10a. A ramp 56a, described below, may also be provided.

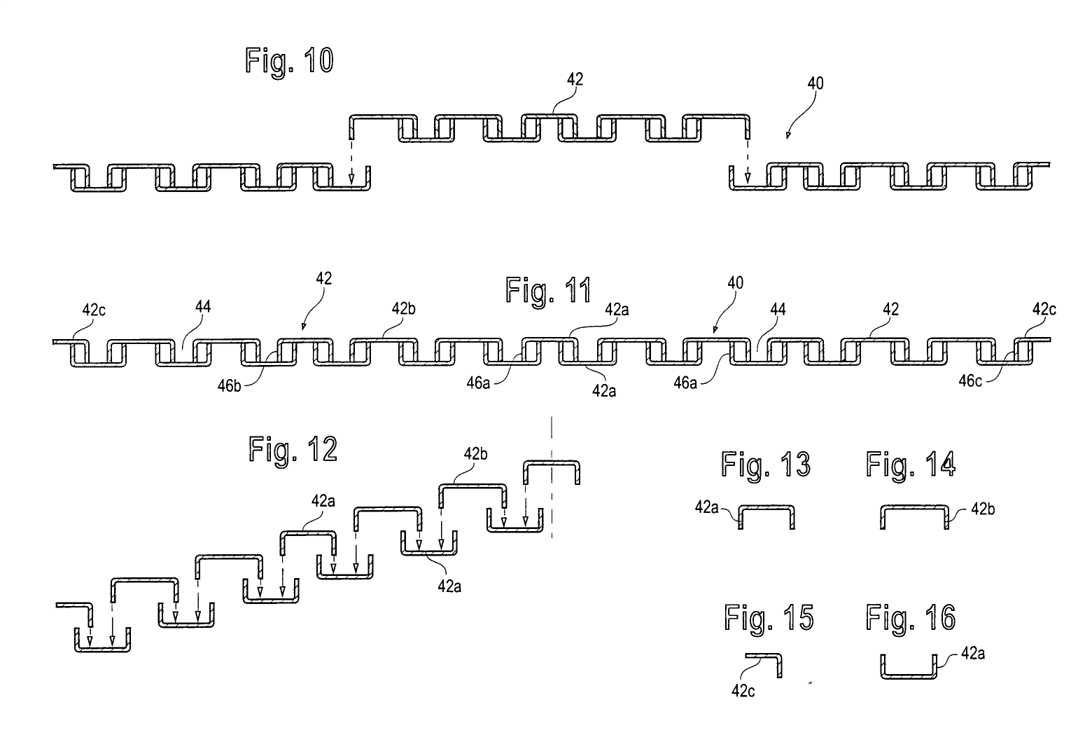

Referring to FIGS. 10-16, a differing design of grooved support surface 40 is shown, comprising an array of individual support modules 42, comprising different designs of support modules 42a, 42b, 42c as shown in FIGS. 13-16. It can be seen that the support modules shown in FIGS. 13 and 16 are of identical design, although positioned oppositely in use. It can also be seen that most of the support modules used in this design are of U-shape, except for the side modules 42c.

By desired arrangement of these respective support modules 42, a grooved support surface having spaced grooves 44 may be provided for the purposes described above. By appropriate use of the differing sized support modules 42a and 42b, the arrangement and width of grooves 44 may be adjusted as desired. The same holds true for the previous embodiment of FIG. 4, considering particularly support modules 16b and 16c.

As seen in FIG. 11, the vertical segments 46a, 46b, 46c may, in this embodiment, be all spaced from each other, providing a certain measure of lateral adjustment to the width of grooved support surface 40, to exactly fit the area allotted to it. The respective vertical segments 46a, 46b, and 46c have edges that enter into a channel which is defined by each horizontal segment of an adjacent support module 42. Such a spacing also provides increased weight support capability for the system.

Thus, the grooved support surfaces of this invention may be used to receive a stack of containers without a pallet, as previously described. Alternatively, a stack of containers may rest upon a flat sheet of material such as corrugated cardboard, thick polyethylene plastic, flat plywood, or the like, which, in turn, is placed upon a respective, grooved support surface such as support surfaces 10 or 40. Such an underlying sheet may be much lower in cost than a pallet, and it can be used to stabilize a stack of smaller packages, which packages may be unitized into a stack by wrapping, strapping, or other techniques. Currently, such unitizing techniques are in commercial use, with the stack resting on a pallet. However, if the packages in the stack are small enough so that stability of the stack is a question, such a flat sheet may be provided under the stack. The increased number of prongs typically used with this invention on the forklift can stabilize such stacks, so that they may be lifted and moved without the use of a pallet, optionally with the use of a support sheet as described above.

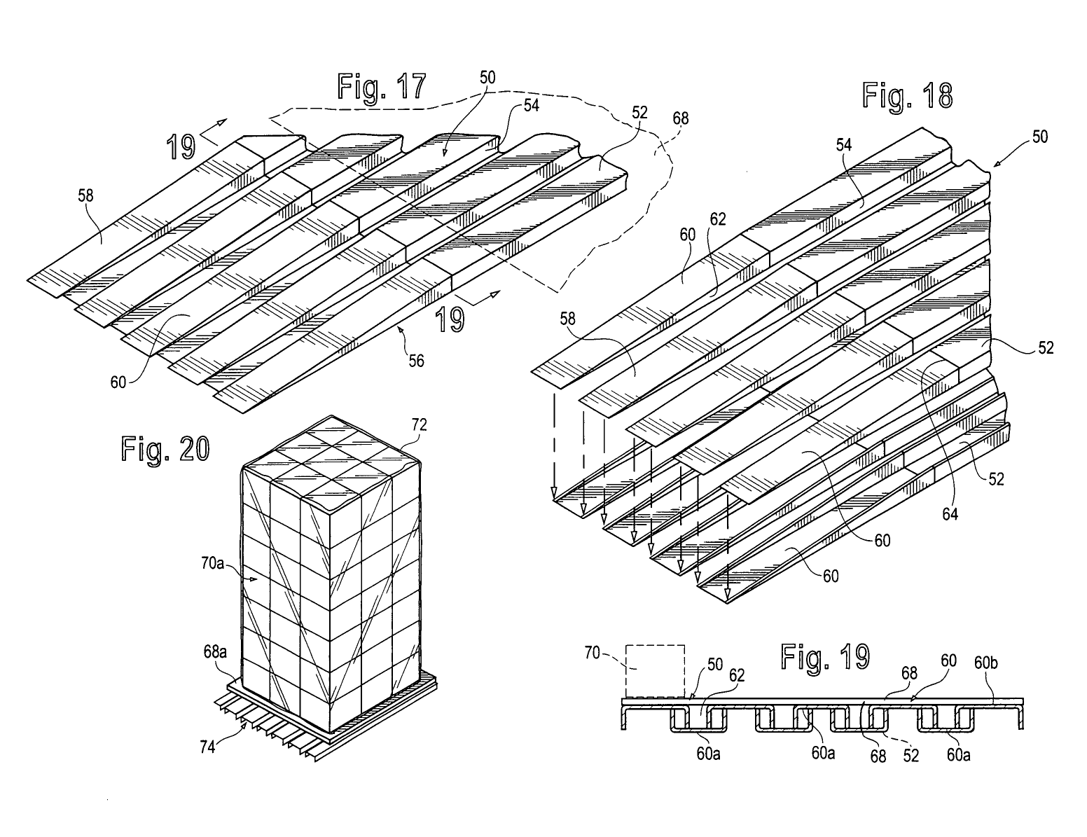

Referring to FIGS. 17-19, another embodiment of the grooved support surface 50 is shown. FIG. 18 shows that most or all of the individual floor modules 52 are of a squared-off U-shape in cross section, defining grooves 54 upon assembly. Grooves 54 for the embodiments shown are typically about 1 to 5 inches deep. Further by this invention, floor modules 52 have ends that are joined to a ramp 56. The purpose of ramp 56 is to permit the advancing lifting vehicle wheels to be gradually lifted onto grooved support surface 50. Also, if the fork of a forklift or the like comes in too low, it will not collide with ends of floor modules 52 with damaging effect, but will gently impact the sloping surfaces 58 of the individual ramp modules 60, which nest together in a manner similar to the floor modules 52, to provide the desired ramp surface 58. The respective floor modules 52 and ramp modules 60 may be secured in place in a manner similar to that described previously with respect to previous embodiments.

Furthermore, it can be seen that the respective floor modules 52 and ramp modules 60 may be of differing designs in the manner similar to the previous embodiments, comprising different-width floor modules 52 and ramp modules 60a and 60b, so that the respective grooves 54, 62 may be adjusted in their width as desired.

Thus, the grooved, sloping surface 58 protects the ends 64 of floor modules 52 from being distorted and bent by banging against a forklift that is coming in too low as it delivers packages. Also, damage to packages can be avoided. A similar ramp 56a is shown in FIG. 1A.

As previously described, a sheet of support material 68 may rest on grooved support surface 50, this sheet of material being made, for example, of plywood, corrugated cardboard, or plastic. The desired load of packages then optionally rests upon sheet 68, on support surface 50. It can be seen that the prongs of a forklift can fit into the grooves 54, 62, to pass under sheet 68, so that sheet 68 and the stack of packages 70 that it carries can be lifted, with sheet 68 providing additional stability to such a stack of packages, when that is needed. For purposes of clarity, stack of packages 70 is represented in FIG. 19 by a single package, but, typically, a substantial number of packages would be carried on sheet 68 in a stack which, in turn, is carried on grooved support surface 50. As stated, typically the forklift used in conjunction with the grooved support surfaces shown herein have at least four prongs, and desirably six or eight prongs that are spaced apart by typically four to seven inches of space between the prongs. The prongs may be on the order of one to four inches wide and about one to four inches thick.

Similarly, FIG. 20 shows a stack of packages 70a, that have been unitized by wrapping in plastic sheeting 72, resting on a plywood or other type of sheet 68a which, in turn, rests on a grooved floor 74 of a type like that described above.

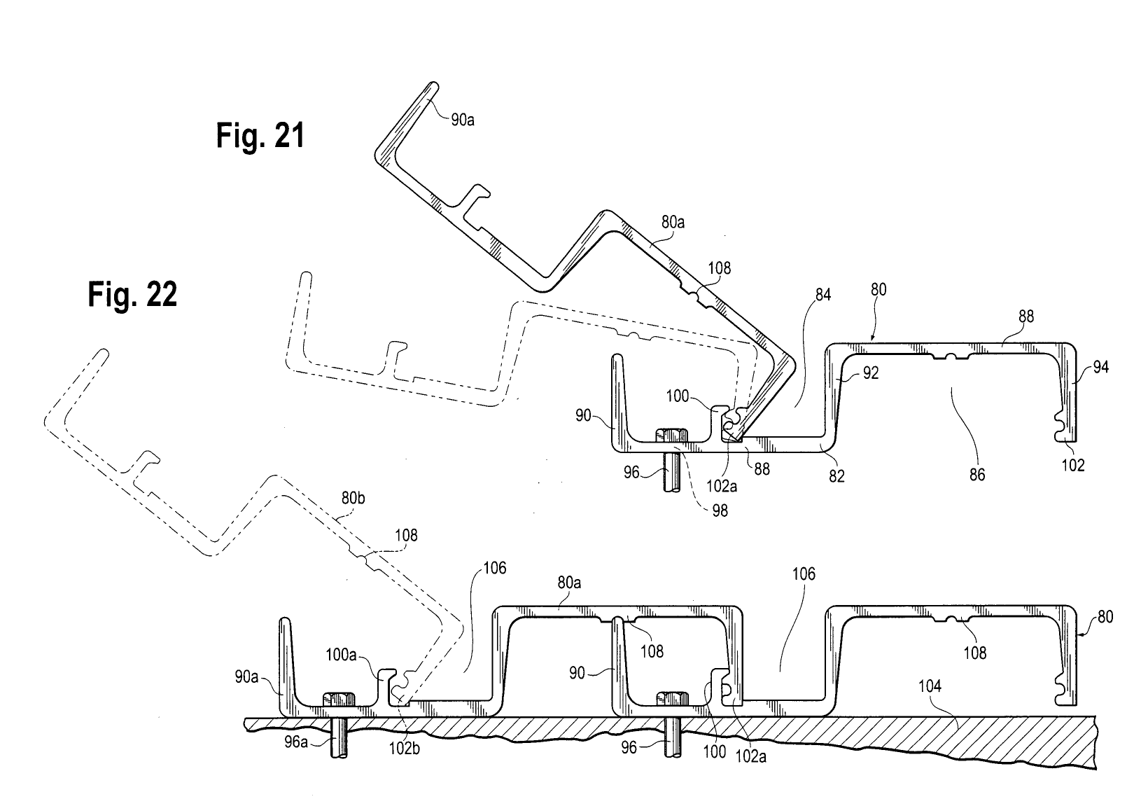

In another embodiment of FIGS. 21 and 22, an elongated module 80, of squared off S cross section as shown, comprises part of a grooved support surface which comprises a lateral array of such modules 80. Module 80 and its companion modules may be made of extruded aluminum, or any other desired metal or plastic. As shown, module 80 comprises a body 82, which defines a pair of elongated channels 84, 86. Each of these channels are respectively defined by one bottom wall 88 and two of the three sidewalls 90, 92, 94 of elongated module 80. The length of module 80 may, as previously described, be of any convenient, multi-foot length, selected for suitable handling of the elongated module. It can also be seen from the presence of screw or bolt 96 that module 80 has an aperture 98 through which bolt 96 may penetrate, for securance of module 80 to a desired subfloor or other support surface.

Furthermore, module 80 defines a first latch member 100, centrally positioned and extending from bottom wall 88 of channel 84. Module 80 also defines a second latch member 102, carried on the outer sidewall 94 that defines the other channel 86. These latch members 100, 102 engage latch members of laterally adjacent modules, as illustrated by module 80a, which may be of identical structure to module 80, shown in FIG. 22 as being laterally connected to module 80 through the engagement of latch 100 of module 80 and latch 102a of module 80a. The respective latches are simple, comprising ribs as shown, and can thus prevent both upward and lateral movement of the modules relative to each other despite the fact that each module may be connected to the subfloor 104 by only a single bolt 96.

FIG. 22 shows in dotted lines a third of said modules 80b, connecting with module 80a and latching with first latch member 100a of module 80a, using the second latch member 102b. By this means, a grooved support surface may be provided, the respective grooves 106 comprising portions of the respective channels 84 in this embodiment, which channels are wide enough to receive forks of a forklift truck, to accomplish the purposes of this invention as previously described. It can also be seen that each bolt 96, 96a can be enclosed in this manner, out of sight, and protected from impact by prongs.

Also, it can be seen how each wall 90, 90a can press its outer end into a socket 108, which is defined in a laterally adjacent, connected module 80a, 80b.

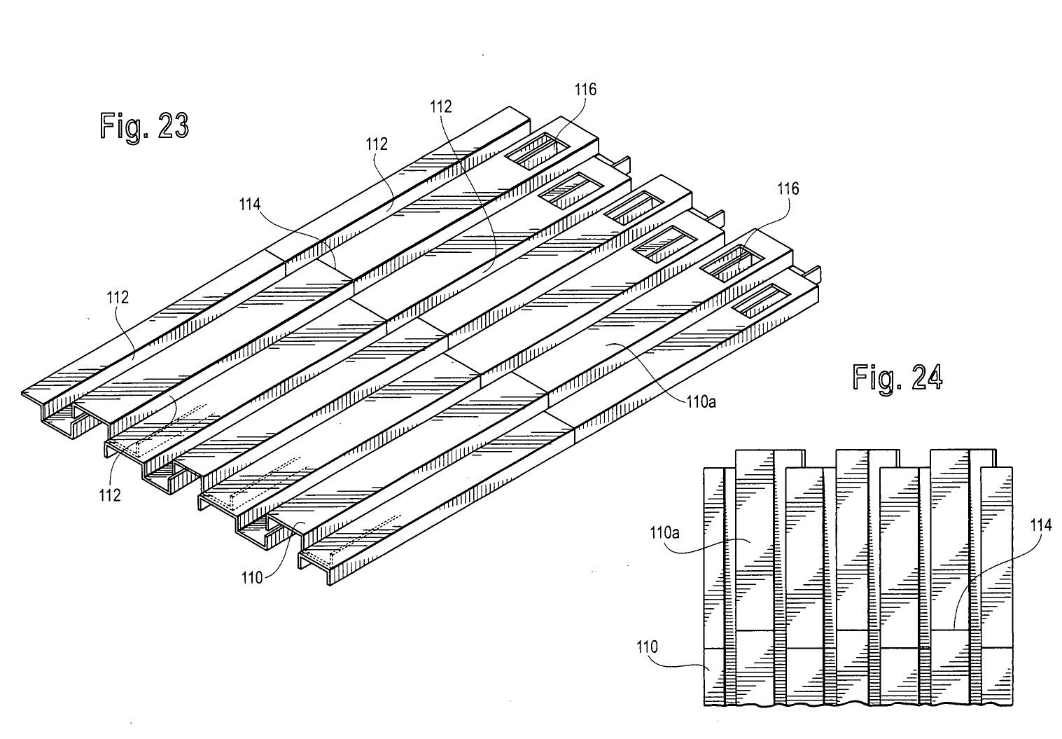

Referring to the embodiments of FIGS. 23 and 24, the respective modules of FIGS. 23 and 24 form a laterally adjacent array, forming a floor having respective grooves 112 with respective modules of 110 of varying design as shown. A second set of end-abutting modules 110a is also provided, so that the respective grooves 112 are lengthened, and extend the length of both modules 110 and 110a.

To avoid a single, linear transverse connection seam, the respective modules are slightly longitudinally offset from each other as particularly shown in FIG. 24, so that the respective connection seams 114 of end-abutting modules 110, 110a do not form a continuous, transverse line, while providing an interlocking support module system.

Also, as shown, the ends of respective modules 110a may define apertures 116, if desired, to facilitate the flow of air underneath the floor defined by the respective modules 110, 110a, to facilitate cooling of packages resting thereon.

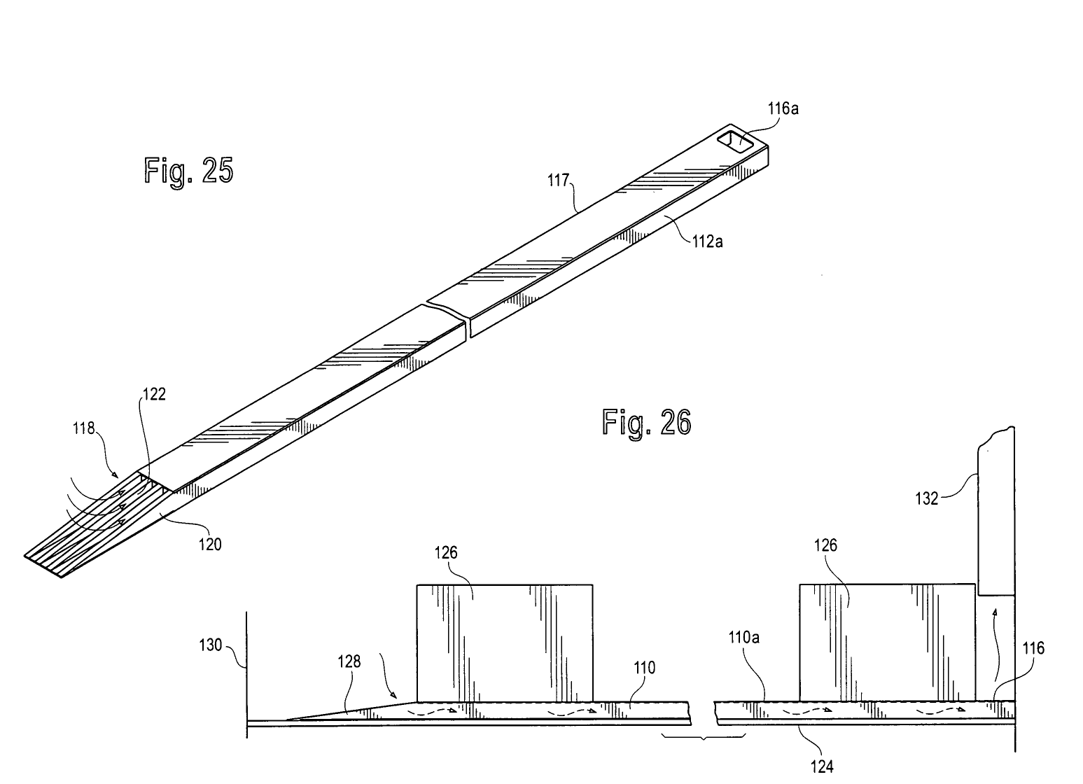

FIG. 25 shows a single floor module, comprising if desired, two or more end-abutting lengths of a floor module, in which an air hole 116a is provided at one end, while at the other end, a ramp 118 is provided, similar to previous ramps, but comprising a series of vertically upstanding triangular plates 120, having spaces 122 between them, to provide access for air. The air may circulate through the spaces 122, through the interior of floor module 117, and out air circulation hole 116a, for the conveyance of, particularly, frigid air to the bottoms of stacks of containers in a refrigerator truck. Since the floor modules may be made of aluminum, heat transfer can be good.

Typically, on each side of a module 117 one finds a groove 112a proportioned in size for the insertion of the prongs of a forklift truck, for the purposes described above.

FIG. 26 is a diagrammatic view, showing how a lateral array of modules such as modules 110, 110a, or 117 can rest on a subfloor 124, and can provide a groove surface to carry product containers 126. A ramp 128, for example, can be positioned to provide slots similar to slots 122, near the rear 130 of a trailer so that refrigeration equipment 132 can cause air to circulate through the slots of ramp 128, similar to ramp 118, within flow channels of modules 110, 110a, and out of aperture 116, for a circulatory, cold air flow.

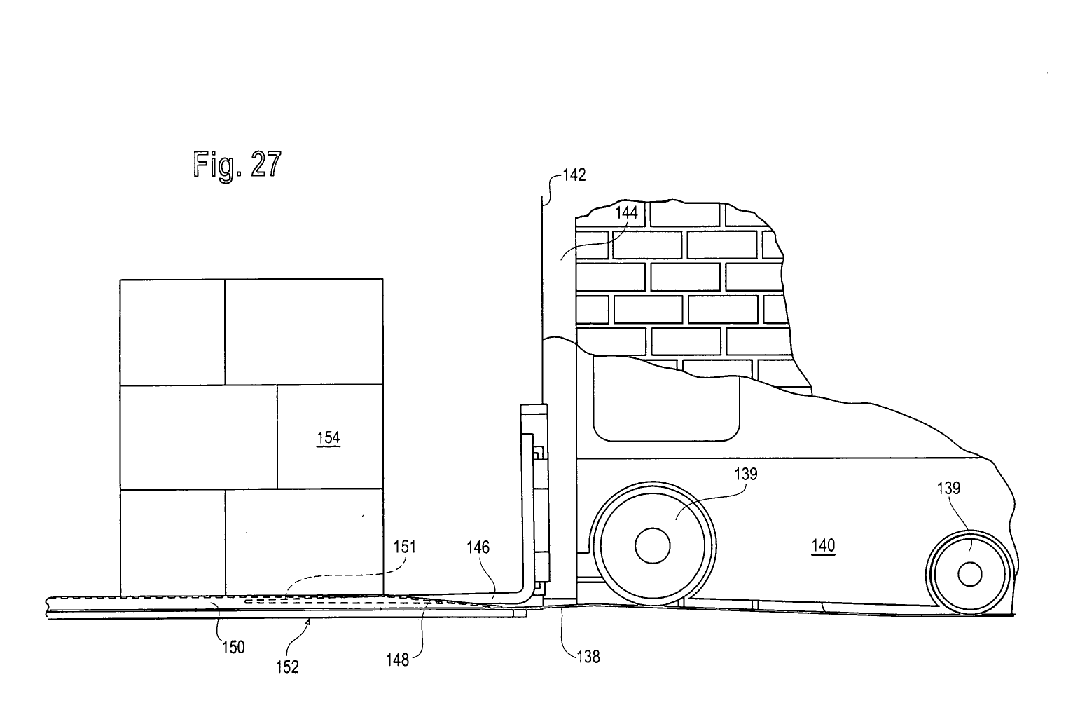

FIG. 27 shows how a conventional dock leveler, (much of which is not shown) having a projectable extension floor 138 permits the wheels 139 of forklift truck or other lifting device 140 to roll into the rear 142 of a trailer across the usual gap 144 between the trailer and the dock.

The forks 146 of forklift truck 140 can be seen to be engaging grooved ramp 148 of a design similar to those previously shown, to enter the grooves 151 of floor modules 150, also of a design similar to that previously shown, resting on a trailer subfloor 152. Thus, product containers 154 that rest on the grooved array of floor modules 150 may be engaged and lifted by forks 146 passing into the grooves 151. Despite the presence of the dock leveler, product may be stacked in trailer 142 to nearly its end, as shown, while still allowing forks 146 to be withdrawn from grooves 151 as forklift truck 140 backs out of trailer 142, without disturbing the last stack of product 154 at the rear of trailer 142.

Accordingly, a system for handling of stacks of containers is provided in which pallets may be partially or completely dispensed with. The grooved floor greatly facilitates the picking up of such containers by a forklift, as does the increase of number of prongs of the forklift to typically four or greater, to provide more sturdy, distributed area weight support under the stack of containers, and thus dispensing with the need for pallets. Thus, such stacks may be stored on shelves or floors without a pallet if desired, and readily picked up for transport, while resting on the grooved support surface of this invention.

Alternatively, packages may rest on pallets, particularly at their destination and their point of origin, but they may be shipped in a palletless manner. Also, particularly for stacks of smaller containers with less stability, a support sheet may be placed underneath the stack to facilitate stability without the need for a pallet. A pallet is defined as a rigid structure defining grooves or recesses to receive forklift prongs, and thus having more depth than a support sheet.

The above has been offered for illustrative purposes only, and is not intended to limit the scope of the invention of this application, which is as defined in the claims below.

1. A grooved support surface, said grooved support surface being defined by a first plurality of support modules held in side-by-side relation together, individual support modules comprising an elongated body having at least a pair of flat segments, joined at a common side edge and extending transversely to each other, said support modules together defining a plurality of spaced, longitudinally extending grooves.

2. The support surface of claim 1 in which at least some of the modules present have a cross section shaped essentially like three sides of a rectangle.

3. The support surface of claim 2 in which some of the modules present have a cross section shaped generally like a squared-off S.

4. The support surface of claim 1 in which some of the modules present have a cross section shaped generally like a squared-off S.

5. The support surface of claim 1 in which at least some of said support modules have ends that are joined to a ramp to permit advancing containers on an advancing forklift to be gradually lifted to engage the grooved support surface without impacting ends of said support modules.

6. The support surface of claim 5 in which the ramp defines extensions of the spaced, longitudinally extending grooves.

7. The support surface of claim 5 in which said ramp comprises a plurality of ramp modules held in side-by-side relation.

8. The support surface of claim 1 in which said support modules are held in said side-by-side relation by tack welding.

9. The support surface of claim 1 in which said support modules are made from extruded aluminum.

10. The support surface of claim 1 in which a second said plurality of support modules, held in side-by-side relation, substantially abuts the first plurality of support modules in end-to-end relation.

11. The support surface of claim 1 which rests on a flat subfloor surface.

12. The support surface of claim 11 in which said subfloor surface comprises the floor of a vehicle.

13. The support surface of claim 11 in which said subfloor surface comprises the floor of a storage room or a storage rack.

14. The support surface of claim 1 in which at least most of said support modules comprise at least one horizontal, flat segment connected at opposite side edges to a pair of vertical, flat segments.

15. The support surface of claim 14 in which at least some of said vertical segments of different support modules which are next to each other are spaced from each other.

16. The support surface of claim 15 in which at least some of said vertical segments have edges that enter into a groove defined at a horizontal segment of an adjacent support module.

17. The support surface of claim 1 in which some of the support modules, in cross section, are of a squared off U-shape and some of the support modules are of a squared off S-shape.

18. A grooved support surface, said grooved support surface being defined by a first plurality of support modules held in side-by-side relation together on a flat subfloor surface, individual support modules comprising an elongated body having at least a pair of flat segments joined at a common side edge and extending transversely to each other, said support modules together defining a plurality of spaced, longitudinally extending grooves, most of said support modules comprising at least one horizontal, flat segment connected at opposite side edges to a pair of vertical, flat segments, at least most of said support modules having ends that are joined to a ramp to permit an advancing lifting vehicle to be gradually lifted to rest on the grooved support surface without impacting ends of said support modules.

19. The support surface of claim 18 in which said ramp defines extensions of the spaced, longitudinally extending grooves.

20. The support surface of claim 18 in which said support modules are held in said side-by-side relation by tack welding.

21. The support surface of claim 18 in which said support modules are made from extruded aluminum.

22. The support surface of claim 18 in which said subfloor surface comprises the floor of a vehicle.

23. The support surface of claim 18 in which said subfloor surface comprises the floor of a storage room or a storage rack.

24. The method which comprises:
placing a stack of containers on a sheet of support material which rests on a first support surface;
advancing prongs of a lifting device into grooves defined in the first support surface, to place the sheet and the stack of containers onto prongs of the lifting device, at least four of said prongs being present, said prongs being spaced apart from each other by no more than about 10 inches;
transporting the containers on the sheet to a new location;
placing the prongs into grooves defined in a second support surface; and
retracting the lifting device, to put the sheet and stack of containers off of the prongs and onto the second support surface.

25. An elongated module for placement on a floor surface in laterally connected relation with other, similar modules, which module comprises:
an elongated body having a cross-section generally like a squared-off S, said body defining a pair of elongated channels having oppositely facing open mouths;
a first interlocking member connected to said body and projecting into one of said elongated channels; and a second interlocking member connected to said body and projecting into the other of said elongated channels.

26. The module of claim 25 in which each of said interlocking members are in connection with an interlocking member of another of said modules in laterally abutting relation therewith.

27. The module of claim 26 in which said modules are longitudinally offset from each other.

28. The module of claim 25, in which each of said elongated, open mouthed channels is defined by a bottom wall and a pair of side walls, said first interlocking member comprising a longitudinally extending bar connected to said bottom wall of one of said channels at a location spaced from the side walls.

29. The module of claim 28 in which said second interlocking member is connected to said side wall which particularly defines the elongated channel that is spaced from the first interlocking member and which defines an outer side of said elongated body.

30. The module of claim 28 in which one bottom wall of an elongated channel defines an aperture for a retaining screw.

31. The module of claim 25 in which one of said elongated channels defines an aperture for a retaining screw.

32. The module of claim 25, in which said floor surface comprises the floor of a vehicle, a storage room, or a rack.
